(19) United States
(12) Patent Application Publication
(10) Pub. No.: US 2003/0106600 A1
(43) Pub. Date: Jun. 12, 2003

(54) Hose closing cap

(76) Inventor: Oliver Ohlendorf, Munich (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/315,785

(22) Filed: Dec. 10, 2002

(30) Foreign Application Priority Data
Dec. 11, 2001 (DE) 101 60 805.5

(51) Int. Cl. F16L 57/00

(52) U.S. Cl. 138/96 R; 138/96 T

(57) ABSTRACT

The present invention relates to a closing cap for a hose and having two cap parts (3a, 3b) sealingly coaxially engageable into each other, and a locking member (4) having a plurality of locking detent elements (5a, 5b) formed integrally with one of the cap parts (3a), and an indentation (6) provided in another of two cap parts (3b) and into which the detent elements (5a, 5b) engage.

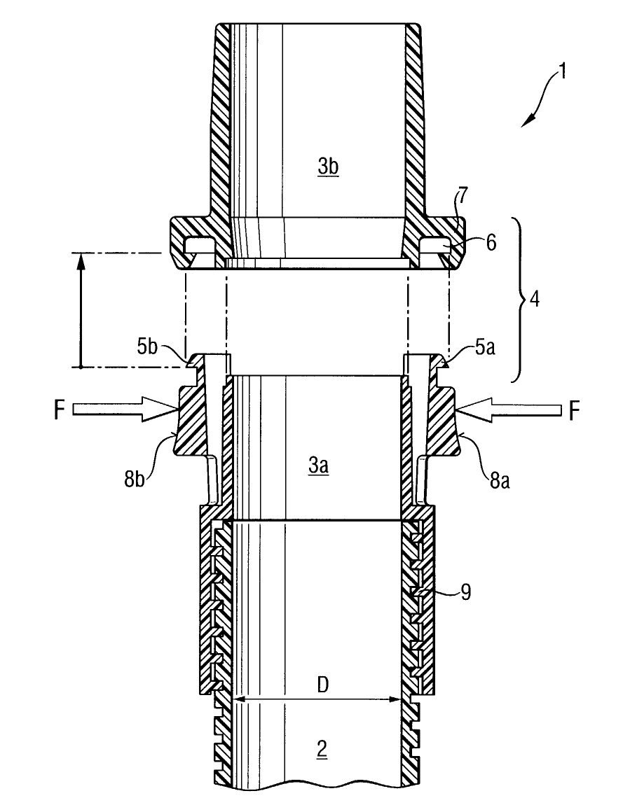

### BACKGROUND OF THE INVENTION

1. Field of the Invention

The present invention relates to a manually releasable, closing cap for a hose, in particular, for a dust suction hose used with hand-held tools such as, e.g., a hand-held grinder.

2. Description of the Prior Art

Generally, hose closing caps are formed of two, tubular, sealingly coaxially engageable into each other, cap parts which are axially secured in their engaging position with a locking member.

European Patent EP-0 140 995 B1 discloses a locking member having a separate detent ring connectable with one of the cap parts and having a plurality of radially elastic detent elements which formlockingly engage, by an axially displaceable locking sleeve, in a circumferential groove provided in the outer profile of the other of cap parts. The drawback of the known closing cap consists in that an additional part, a detent ring, is needed and which is technologically expensive.

An object of the present invention is to provide a manually releasable, hose closing cap which can be technologically simply produced.

### SUMMARY OF THE INVENTIONS

This and other objects of the present invention, which will become apparent hereinafter, are achieved by providing a closing cap having two tubular cap parts sealingly coaxially engageable into each other, and a locking member having a plurality of locking detent elements formed integrally with one of the cap parts and an indentation provided in another of two cap parts and into which the detent elements engage.

Forming the locking detent elements integrally with one of the cap parts can be easily realized by forming the cap part and the detent element, which can be formed of a plastic material, by using a technologically simple, injection molding process.

An automatic locking of the cap is insured when the locking detent elements are radically resiliently preloaded in a direction toward the indention.

Advantageously, the indentation is provided over the entire circumference of the second part, whereby there is provided, with respect to the cap, a rotational degree of freedom which prevents twisting of the hose.

Advantageously, the locking member is provided in the radially outer region of the cap parts which permits to pin the cap on the hose or to insert the hose into the cap, without the inner diameter cross-section of the hose being changed. This prevents curling of the hose which leads to reduction of pressure and dust deposits.

Advantageously, the indentation is formed as an inner, cap side-open groove provided in a radially outer, annular collar with the radially resilient locking detent elements, which are resiliently preloaded radially outwardly and automatically formlockingly engage in the inner groove. Such formation of the locking member provides for release of the cap upon application of radial pressure to the detent elements.

Advantageously, there are provided two, radially resilient, resiliently preloaded radially outwardly, diametrically opposite, detent elements, which provides for an easy release of the cap with one hand by grasping the detent elements between the thumb and the forefinger.

Advantageously, the two detent elements a provided in their cap end region with gripping surfaces which facilitates the release of the cap.

Advantageously, the first cap part is provided at its hose side region with an offset radially outwardly inner thread which provides for screwing in of a thread-like hose.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

In the Drawings:

Single FIGURE of the drawings shows a hose closing cap according to the present invention.

### DETAILED DESCRIPTION OF THE PREFERRED EMBODIMENT

A closing cap 1 according to the present invention, which is shown in the drawing in an open condition, is designed for closing a hose 2 having an inner diameter 2. The closing cap 1 has two cap parts 3a and 3b, which are sealingly, coaxially inserted into each other, and a locking member 4 provided in an outer radial region of the coupling parts 3a, 3b. The locking member 4 has two, diametrically opposite radially resilient locking detent elements 5a, 5b which are associated with the first hose part 3a, and an indentation 6 which is formed in the second hose part 3b and into which the detents elements 5a, 5b engage. The closing detent elements 5a, 5b are formed integrally with the first hose part 3a and are resiliently connected therewith. The indentation 6 is formed as an inner, cap side-open groove in a radially outer, annular collar of the second hose part 3b. The radially resilient, locking detent elements 5a, 5b, which are resiliently preloaded against a force F, formlockingly engage into the inner circumferential groove 6. The locking detent elements 5a and 5b are provided, in their side end region with gripping surfaces 8a, 8b, respectively. The first hose part 3a is provided at its hose side end with a radially outwardly offset, inner thread 9.

Thought the present invention was shown and described with reference to the preferred embodiment such is merely illustrative of the present invention and are not to be construed as a limitation thereof and various modifications of the present invention will be apparent to those skilled in the art. It is therefore not intented that the present invention be limited to the disclosed embodiment or details thereof, and the present invention includes all variation and/or alternative embodiments within the spirit and scope of the present invention as defined by the appended claims.

What is claimed as:

1. A closing cap for a hose, comprising two tubular cap parts (3a, 3b) sealingly coaxingly engageable into each other; and a locking member (4) having a plurality of locking detent elements (5a, 5b) formed integrally with one of the cap parts (3a), and an indentation means (6) provided in another of two cap parts (3b) and into which the detent elements (5a, 5b) engage.

2. A closing cap according to claim 1, wherein the detent elements (5a, 5b) are radially resiliently preloaded in a direction toward the indentation means (6).

3. A closing cap according to claim 1, wherein the indentation means (6) is formed as a circumferential groove.

4. A closing cap according to claim 1, wherein the locking member (4) is arranged in a radially outer region of the cap parts (3a, 3b).

5. A closing cap according to claim 4, wherein the indentation means (6) is formed as a inner, cap side-open groove provided in a radially outer annular collar 7, and wherein the radially resilient locking detent elements (5a, 5b), which are resiliently preloaded radially outwardly, automatically formlockingly engage in the inner groove.

6. A closing cap according to claim 5, wherein the plurality of locking detent elements (5a, 5b) comprises two, diametrically opposite, radially resilient, resiliently preloaded radially outwardly, locking detent elements (5a, 5b).

7. A closing cap according to claim 6, wherein the two detent elements (5a, 5b) are provided in a cap side end region thereof with gripping surfaces (8a, 8b).

8. A closing cap according to claim 1, wherein one of the cap parts (3a) is provided in a hose side region thereof with an inner thread (9) offset radially outwardly.
